(19) United States
(12) Patent Application Publication
(10) Pub. No.: US 2025/0173812 A1
(43) Pub. Date: May 29, 2025

(54) Dynamically Allocated Memory-Backed Traversal Stack for Ray Tracing Hardware

(71) Applicants: ATI Technologies ULC; Advanced Micro Devices, Inc., Santa Clara, CA (US)

(72) Inventors: David William John Pankratz, Montreal (CA); Michael John Livesley, Edinburgh (GB); David Kirk McAllister, Holladay, UT (US)

(21) Appl. No.: 18/519,521

(22) Filed: Nov. 27, 2023

(51) Int. Cl. G06T 1/60; G06T 15/06

(52) U.S. Cl. CPC G06T 1/60; G06T 15/06

(57) ABSTRACT

Systems and methods for efficient memory management during ray tracing are described. A ray tracing system assigns a memory stack to a ray. The ray, when intersection tested against objects of a node, accesses data that is stored in the memory stack. When data is to be consumed from the memory stack by the ray, the ray tracing system uses a memory pointer associated with the ray to locate the requested data. When data is to be stored to the memory stack, the memory allocation circuitry stores data in a free memory block and uses a linked list to link the memory block with other memory blocks storing additional data for the ray.

### BACKGROUND

### Description of the Related Art

In the process of testing for object intersection using simulated light rays, known as ray tracing, pixels are colored according to the outcome of the ray cast. Compared to rasterization-based methods, ray tracing is more computationally intensive but outputs are more accurate. Improvements to methods used for ray tracing operations have continuously been of interest.

Generally, a significant amount of computation is required to find intersections between rays and objects in a scene. A straightforward approach would involve testing every ray against every primitive in the scene, and then identifying the closest intersection among all the hits. However, this approach becomes impractical when dealing with scenes that contain millions or billions of primitives, and a large number of rays to process, possibly in the millions. As a result, ray tracing systems commonly utilize an acceleration structure that describes the scene's geometry in a way that minimizes the computational workload for intersection testing.

Allowing parallel BVH traversal gives efficiency benefits over simply increasing the number of rays actively traversing as per-ray storage is large and this has a serious storage and therefore silicon area overhead. However, determining when to introduce parallelization is a decision made dynamically, and over time, processing a wider BVH for some rays may leave other rays without computational resources, or with much less computational resources than other rays, which can skew the quality of service for some rays relative to others, thereby degrading performance. To manage the system and balance behavior, both allocating and deallocating resources dynamically during a workload is desirable.

In view of the above, improved systems and methods to achieve desirable ray traversal performance for GPU-based BVH construction methods are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 is an illustration of a bounding volume hierarchy (BVH).

FIG. 4A illustrates block diagram for dynamic memory stack allocation for storing ray data.

FIG. 4B illustrates block diagram for dynamic memory stack deallocation for consumption of ray data.

FIG. 5 illustrates an exemplary method for dynamic allocation and deallocation of memory stacks during ray tracing.

FIG. 6 illustrates an exemplary parallel BVH traversal using work items.

FIG. 7 illustrates an exemplary block diagram for memory stack linking for work items during parallel BVH traversal.

FIG. 8 illustrates an exemplary method for memory stack linking for work items during parallel BVH traversal.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for efficient memory management during ray traversal are described. In one or more implementations, memory-backed stacks with dynamic allocation are used to store information generated during intersection testing of a ray against one or more nodes of an acceleration structure. In an implementation, blocks of memory are allocated dynamically by a memory allocation circuitry. These memory blocks are linked together to form a memory stack, using a single linked list, such that each memory block points to the next block deeper in the memory stack. Data from the top-most block of this memory stack is popped off for intersection testing. For instance, during intersection testing, data associated with a root node of the acceleration structure is popped off from the top most memory block of the memory stack and the ray is tested against the root node. Data pertaining to all child nodes identified for future traversal and testing is moved to subsequent blocks in the memory stack. In an implementation, the memory stack is assigned for storing the data dynamically, in that memory blocks from the memory stack are assigned to rays that need them, without preassigning any memory blocks to any rays. Further, during consumption of data from the memory stack, the data can be accessed using memory pointers that point to the memory blocks where requested data is located.

In the implementations described herein, “ray” stacks are stacks used to store data associated with a ray (e.g., buffers used to store ray data). In an example, the ray data corresponds to information on one or more nodes that the ray traverses in a hierarchical data structure. As used herein, a “ray stack,” “ray stack buffer,” or “ray stack block” is a local buffer including one or more memory blocks/locations for storing data associated with a ray and/or ray tracing operations. In various implementations, the ray stacks have a fixed size and are located in a memory local to ray tracking circuitry operating on the ray data. Further, in one or more implementations, additional memory may be allocated to store data associated with a ray stack. For example, if a ray stack is full and can no longer store data, additional memory can be allocated (e.g., in a system memory or other memory) to store data associated with the ray stack. These additional memory locations are assigned to the ray stack using a link(s), mappings, or any other suitable mechanism. As more memory is allocated, the allocated memory locations are maintained in such a way that they are all associated with the ray stack. For example, the allocated memory locations may be linked to one another using metadata (e.g., pointers, etc.) to form a stack or other data structure. These linked memory locations allocated in the system or other memory are referred to as “memory” stacks. In one implementation, if an attempt is made to store data in a ray stack that is full (e.g., owing to the small and fixed storage capability of the ray stack), memory can be allocated (from the memory stack) to provide additional storage space. Said differently, if memory buffer space for a ray is full, additional space in the other memory is allocated for the ray and the other memory can then store data that associates the allocated memory with the ray stack. In various implementations, additional memory may be allocated for a ray stack even when then ray stack is not full.

In an implementation, data corresponding to nodes of the acceleration structure can be stored in a manner that data associated with a node currently being traversed is stored in the ray stack. Further, data corresponding to other nodes (e.g., nodes to be traversed in the future) is stored in the memory stack (e.g., when the ray stack is full). Further, memory blocks in the memory stack that store data for a single ray are connected with one another using pointers.

In an implementation, ray stacks can reside in a system memory, e.g., Random Access Memory (RAM), that could be a volatile memory used to temporarily store data and programs that are actively being used or processed. Further, memory stacks can reside in a cache or local memory that can act as a buffer between the system memory and the ray tracing circuitry. The memory allocation and deallocation, in one example, can be performed in a memory-backed structure following the Last-In-First-Out (LIFO) principle. That is, the system memory used to store data associated with a ray (e.g., data corresponding to a root node to be tested) is backed up by a local memory to provide additional storage space for child nodes identified as candidates for traversal as a result of testing of the ray against the root node.

In various implementations, the dynamic memory stacks are further utilized in parallel BVH traversal using work items to manage BVH traversal width. Every work item is associated with a given memory stack comprising memory blocks storing node data for nodes processed by the work item. In cases where a work item is to be reassigned to work on a different ray, the memory blocks storing data for the work item are linked (or patched) to memory blocks of another work item working on the same ray, thereby preserving data for future use. Once the linking is complete, the work item can be free to be reassigned to process another ray. These and other implementations are presented.

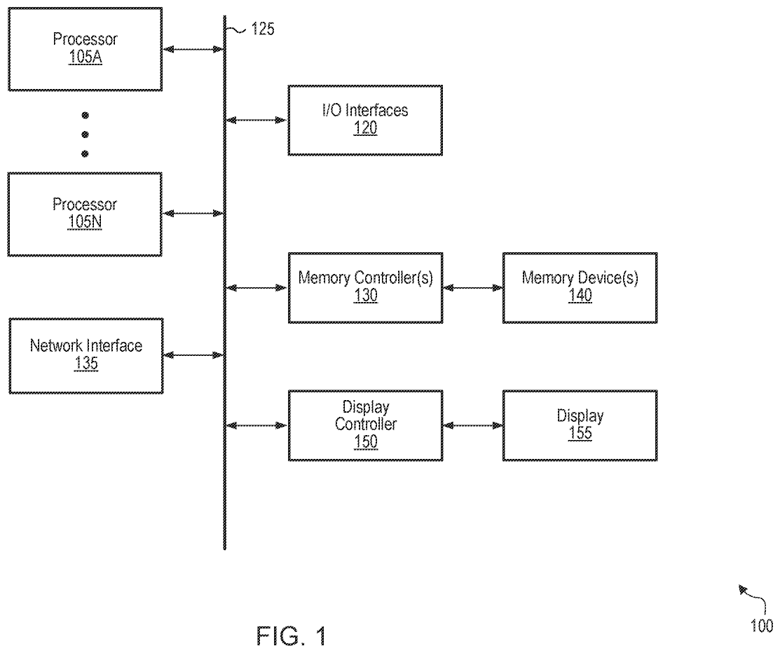

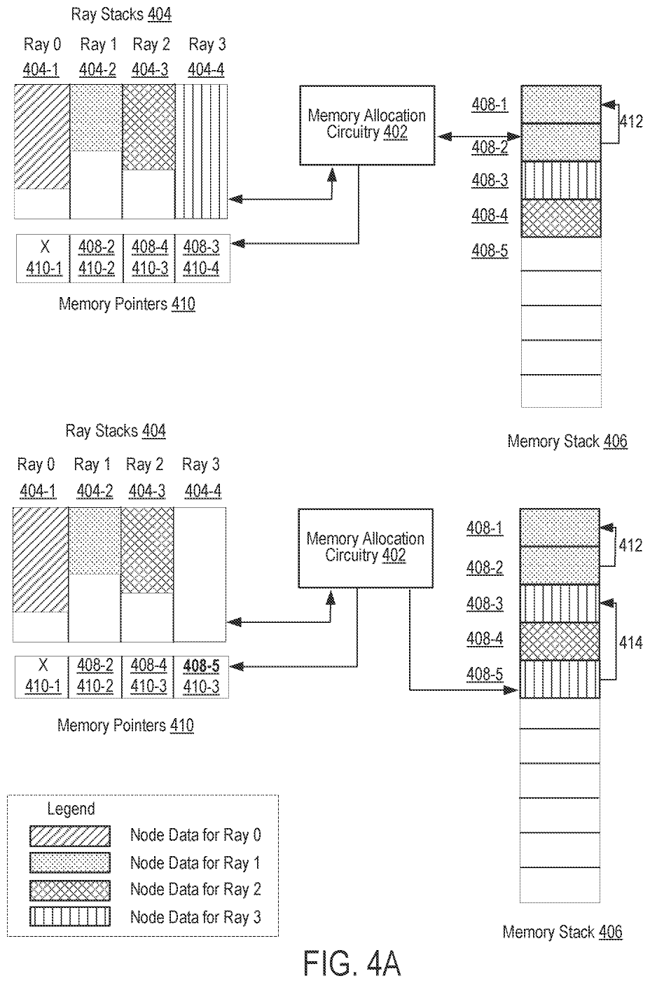

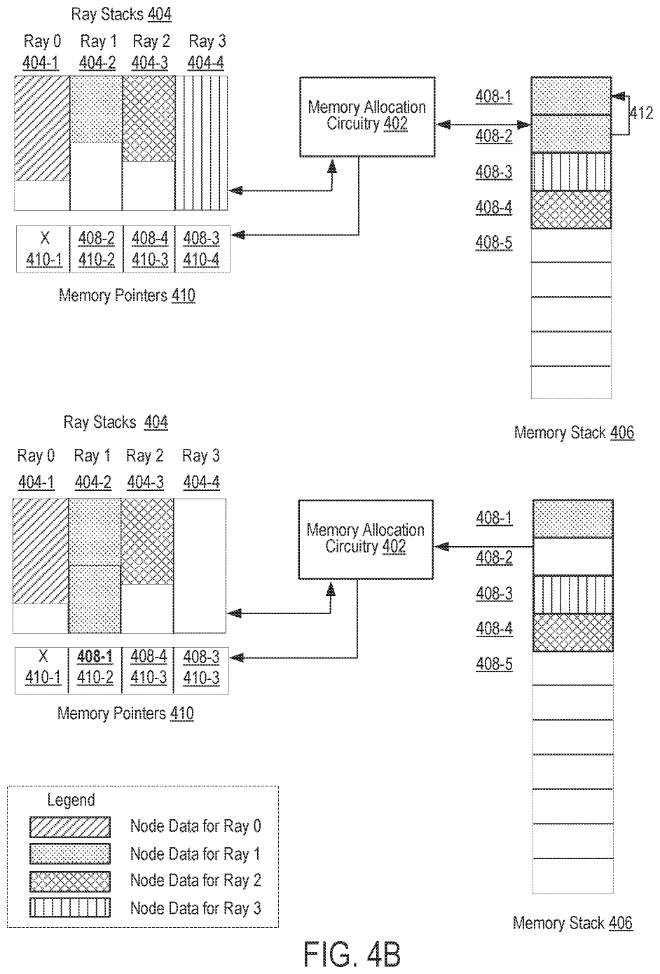

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-9 herein.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

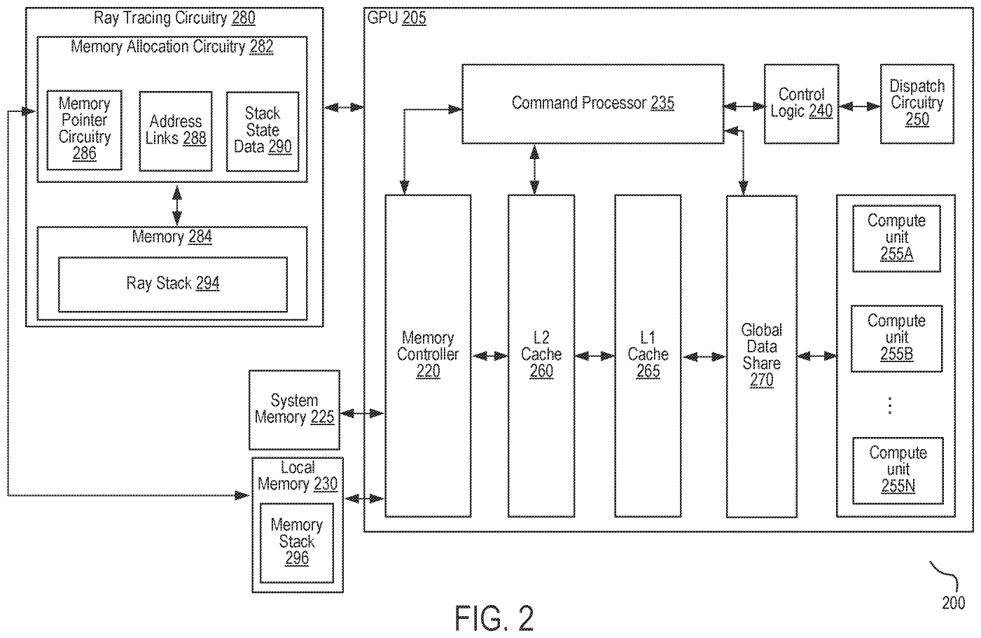

Turning now to FIG. 2, a block diagram of another implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes ray tracing circuitry 280 including memory allocation circuitry 282, and memory 284. The memory allocation circuitry 282 further includes memory pointer circuitry 286, address link circuitry 288, and stack data 290.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N.

In one implementation, ray tracing circuitry 280 implements ray tracing, to render a 3D scene by using an acceleration tree structure (referred to as a bounding volume hierarchy or BVH) to perform ray tracing operations, including testing for intersection between light rays and objects in a scene geometry. In some implementations, much of the work involved in ray tracing is performed by programmable shader programs, executed on the compute units 255A-N, as described in additional detail below.

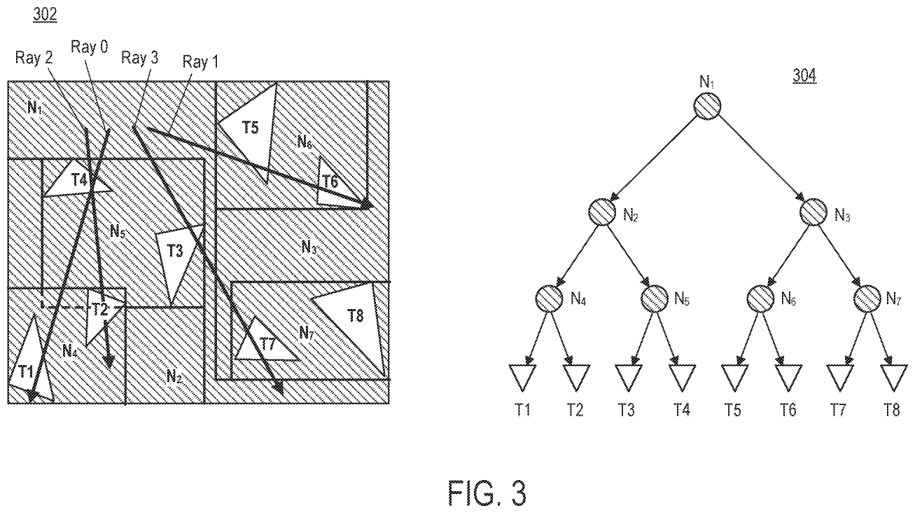

The ray intersection test fires a ray from an originating source, determines if the ray intersects a geometric primitive (e.g., triangles, implicit surfaces, or complex geometric objects), and if so, determines the distance from the origin to the intersection of the triangle. In an implementation, ray tracing tests use a spatial representation of nodes, such as those comprises in the BVH. In the BVH, each non-leaf node represents an axis-aligned bounding box that bounds the geometry of all children of that node. In one example, a root node represents the maximum extent over the area over which the ray intersection test is being performed. In this example, the root node has two child nodes, each representing a bounding box that typically divides the overall area. Each of these two child nodes has two child nodes also representing bounding boxes. Leaf nodes represent triangles or other geometric primitives on which ray intersection tests are performed (described in FIG. 3).

Further, in an implementation, based on the tracing of rays within a scene geometry, BVH structures are formed by command processor 235 and are stored in system memory 225 and/or local memory 230. A tree is loaded onto a memory, and the command processor 235 further executes optimizations on the hierarchical tree. Once a given BVH is optimized, ray intersection tests are performed again and the ray tracing circuitry 280 uses the optimized BVH to retest ray intersections in a given scene geometry. These tests are used by shader programs running on the compute units 255A-N to generate images using ray tracing accelerated by the optimized BVH. The updated images are then queued for display by command processor 235.

In one implementation, during ray tracing, the memory allocation circuitry 282 handles storage of data in one or more memory blocks of the ray stack and/or a memory stack. In specific instances, the ray tracing circuitry 280 acquires data that contains information about nodes of a hierarchical acceleration structure, that are to be visited when the ray traverses the acceleration structure. In an implementation, this information can include addresses of the nodes that would be visited during traversal of the acceleration structure. In one implementation, data corresponding to a node currently being traversed by a given ray (e.g., a root node) is stored in a ray stack 294. The ray stack 294 is a fixed-size memory allocated for a given ray and is resident in the memory 284. Further, data for subsequent nodes to be visited during traversal by the given ray is stored in a memory stack 296, e.g., when the ray stack 294 is full and cannot store additional data. The memory stack 296 is stored in local memory 230. In an implementation, the ray stack 294 resident in memory 284 and the memory stack 296 located in the local memory 230 cumulatively store the data for each ray, such that the blocks of memory are linked together in order from top to bottom. In one implementation, the topmost block of the memory stack 296 and subsequent blocks of the memory stack 296 are connected by a single linked list.

In an implementation, the sequence of storage of data in the memory stack 296 can be based on a heuristic determination. For instance, nodes can be sorted via a heuristic determining which node is most likely to contain the closest hit for the ray (for example by the largest overlap time the ray is in the box) and then pushed to the memory stack in reverse order, i.e., the best choice node in the topmost block of the memory stack 296, followed by other nodes in subsequent memory blocks of the memory stack 296.

In an implementation, each time a ray intersection test is performed for the given ray, i.e., the ray is processed for objects in a node, new nodes to be visited are determined, e.g., based on the ray hitting an object during a box test. As the ray stack 294 may have limited storage capacity, e.g., capacity to only store data for a finite number of nodes in the memory 284, the data on other nodes determined to be of interest is stored using memory stack 296, as described above. In an example, node data includes node metadata for nodes identified as candidates for intersection testing. According to the implementation, the memory stack 296 can be allocated in the local memory 230, such that the data can be moved, dynamically, between the ray stack 294 and memory stack 296 by the memory allocation circuitry 282. In one implementation, the memory stack is a data structure that stores and manages data in a Last-In-First-Out (LIFO) manner. The memory stack 296 can store abstract data types and operate on the principle of two main operations, i.e., data push and data pop. These operations are described in further detail with respect to FIGS. 4A-B.

In an implementation, data movement between memory stack 296 and ray stack 294 can be performed with the help of memory pointers. For instance, each ray is assigned a memory pointer such that the assigned memory pointer points towards the topmost block of the memory stack 296, where data pertaining to nodes is stored and can be consumed from. Further, each time a block of the memory stack 296 is consumed, or data is stored in an empty block for a given ray, the memory pointer assigned to that ray is updated by the memory allocation circuitry 282. In another implementation, the memory allocation circuitry 282 generates address links, such that during data push, each address link represents a link between the memory stack 296 associated with the given ray, e.g., linking a last filled block of the memory stack 296 for the ray to each preceding block of the memory stack 296 filled for the same ray, till an end of the memory stack 296 for the ray is reached. Similarly, when data is popped from the memory stack 296, links from empty memory stack blocks to other blocks are terminated and these blocks are freed up for use by other rays.

In one example, information about an assigned memory stack 296, such as memory block status, used and unused bits, top of the stack indicator, stack capacity, and the like can be stored as stack state data 290. Further, memory pointers are generated and updated by the memory pointer circuitry 286 and the address links linking memory stack blocks of the memory stack 296 are saved as address links 288.

In an implementation, ray tracing circuitry 280 as described herein refers to specialized hardware components or dedicated processing units designed to accelerate ray tracing, a rendering technique used in computer graphics to generate highly realistic images by simulating the behavior of light. Further, memory allocation circuitry 282 can include memory allocator hardware such as hardware memory management units (MMUs), designed to assist in the allocation and deallocation of memory in a computer system. MMUs are responsible for managing the virtual memory system, translating virtual addresses to physical addresses, and providing memory protection. In various implementations, the memory pointer circuitry 286 includes memory pointer hardware used to manage and manipulate memory addresses in a computer system. In an implementation, the memory pointer circuitry 286 can include memory address registers, memory data registers, address decoders, and control logic to read, write, and modify memory addresses. In an alternate implementation, the memory allocation circuitry 282 can further include memory counters (not shown) configured to keep track of memory addresses or locations. These memory counters can be used in conjunction with memory pointer circuitry 286 to facilitate efficient data access and manipulation in linked-list based memory stacks.

FIG. 3 is an illustration of a bounding volume hierarchy (BVH), according to an implementation. For simplicity, in the exemplary implementation depicted in FIG. 3, the hierarchy is shown in two-dimension. However, in various alternate implementations, extension to three-dimension may be possible, and it should be understood that the methods described herein would generally be applicable to three-dimensional hierarchies as well.

The spatial representation 302 of the BVH is illustrated in the left side of FIG. 3 and the tree representation 304 of the BVH is illustrated in the right side of FIG. 3. In one example, the bounding volumes are represented by “N,” such that N1-N7, are distinct bounding boxes. In the example, bounding box N1 encompasses all other bounding boxes N2-N7. Further, each bounding box N2-N7 includes one or more triangles, that represent geometric objects, and are denoted by “T.” For example, bounding box N1 includes all other bounding boxes and their respective triangles T1-T8. In a similar manner, bounding box N2 includes smaller bounding boxes N5 and N4, such that N4 includes triangles T1 and T2, and N5 includes triangles T4 and T3. Further, for the sake of brevity, in the tree representation 304 the bounding boxes are each represented by a non-leaf node “N” and each triangle is represented by leaf nodes T.

In order to perform ray tracing for a scene, a processing unit (e.g., ray tracing circuitry 280 of FIG. 2) performs a ray intersection test by traversing through the tree 304, and, for each bounding box tested (i.e., by traversing respective internal nodes N), eliminating branches below a traversed node if the test for that node fails. In one example, it is assumed that ray 1 intersects triangle T5 as the closest hit. The processing unit would The processing unit would test against bounding box N1 and then after returning a hit, fetch the resulting child node, which contains bounding boxes for the next level of hierarchy below N1 (nodes N2 and N3). When this node data returns from memory, bounding boxes for N2 and N3 are tested. The processing unit returns a fail or miss result against bounding box N2 (since ray 1 does not interact with the bounding box). The processing unit eliminates all sub-nodes of node N2. Since ray 1 does interact with bounding box N3, it would return a hit and then subsequently fetch N3 from memory, which contains bounding boxes for N6 and N7. Tests are then performed against bounding boxes N6 and N7, by traversing through their respective representative nodes N6 and N7, noting that the test for node N6 succeeds but for node N7 fails. The processing unit would then test triangles T5 and T6 by traversing through representative leaf nodes T5 and T6, noting that test determines that T5 is the closest hit for the ray, and therefore the test for T5 succeeds, but T6 fails (even though the ray might hit T6, however it is not the closest hit).

In an implementation, the BVH 304 is generated using a given scene geometry. The scene geometry includes primitives that describe a scene comprising one or more geometric objects, which are provided by an application or other entity. In one implementation, software executing on a processor, such as the command processor 235, is configured to perform the functionality described herein, hard-wired circuitry configured to perform the functionality described herein, or a combination of software executing on a processor and hard-wired circuitry that together are configured to perform the functionality described herein. In various examples, the BVH 304 is constructed using one or more shader programs, such as executing on the processing unit, or on a hardware unit in a command processor. In various embodiments, the BVH 304 is constructed prior to runtime. In other examples, the BVH 304 is constructed at runtime, on the same computer that renders the scene using ray tracing techniques. In various examples, a driver, an application, or a hardware unit of a command processor performs this runtime rendering.

In an exemplary implementation, a data structure comprising one or more data fields, each containing information pertaining to the different nodes of the BVH 304, for which intersection testing is to be performed, is stored in a memory location accessible by the processing unit. For example, the data structure is stored in system memory 225 or local memory 230, such that each time a hierarchical tree is created and/or updated, the data structure is updated by the processing unit. An exemplary data structure includes node metadata such as, but not limiting to, node identifiers, node surface areas, node subtree information, node lock status, and node bounding boxes, etc.

In one implementation, when ray tracing requests are received for a ray, by the processing unit, these requests are stored in a ray stack associated with the ray. As described in the foregoing, multiple nodes are selected as candidates for ray testing for a given ray. For example, in the above tree 304, two child nodes N2 and N3 are identified for the parent node N1. In traditional ray tracing systems, node N2 and its subtree (containing nodes N4 and N5 and their respective triangles) are tested against a ray, and the node intersection results (e.g., node data for identified nodes of interest) as a result of such testing is stored in a memory buffer. Once all the subtree nodes for node N2 are traversed and tested, node N2 is again traversed to identify which nodes are to be traversed next. Since node N3 is the sibling node for node N2, node N3 is traversed next for testing. Such ray tracing systems exhibit large computational workloads since nodes of the subtree are to be traversed multiple times in order to identify subsequent nodes to be traversed.

One possible solution for eliminating this additional workload is to use memory stacks during traversal of the acceleration structure. In an implementation, using a memory stack for a given ray, data pertaining to each node determined as a candidate node to be visited is pushed onto the memory stack, in response to the ray stack initially assigned for the ray reaching its storage capacity. For instance, when such candidate nodes are determined during box tests, data for each node is first pushed onto the ray stack, e.g., the ray stack storing data for the node identified as the best choice node, e.g., closest hit during ray intersection test. Further, data for other candidate nodes is pushed to blocks of a memory stack and these blocks are linked using a linked list. Since, data for nodes that are to be tested subsequently is already stored in an accessible memory structure, this data can be popped to identify which node is to be tested against the ray at any given point during the intersection testing. This advantageously mitigates the need for repeat testing to know what nodes to visit, especially when the ray stack memory is full. In the example shown, after testing N1, if N2 and N3 are determined as nodes of interest, data doe node N3 can be pushed to the memory stack and data for node N2 is read from the ray stack. That is, when traversal for the subtree below N2 is complete, retesting node N3 to know what to do next is not required anymore.

In some implementations, multiple subtrees can be traversed using parallel BVH traversal. Parallel BVH traversal may allow better scaling of systems since only a number of memory stacks are to be scaled, which is cheaper since a majority of the memory stack is reusable memory which reduces the overall silicon area for the ray tracing system. This allows for a reduction in memory latency and improvement in performance. However, with parallel BVH traversals, memory stack management can be difficult to achieve. Current ray tracing systems that use memory stacks assign finite storage on-chip, in order to maintain data pertaining to nodes to be traversed. However, if the memory stack is implemented in finite storage, some methodology must exist to recover data which is lost if new nodes pushed to the memory stack and overwrites old data. If the memory stack is implemented with memory backing, when storage becomes full, data is written to a memory location which can be determined from an id or index associated with the ray. This requires a memory buffer to be allocated by a driver, and for the driver to determine how large the memory buffer should be, which is a function of the maximum traversal stack depth supported, and the number of rays in flight at a time. This is known as static memory backed ray stack management, and the cache efficiency for such static memory management systems is low, since the finite storage could cause overflow of the memory stack and/or under allocation of the memory buffer space.

In one or more implementations described herein, the BVH traversal is performed using a dynamic (real-time) memory backed stack allocation. In an implementation, each time multiple nodes are identified for intersection testing, a given node is selected for traversal and the node addresses for the remaining nodes are pushed to a memory stack dynamically accessible by the ray tracing circuitry. Referring again to the example of the acceleration structure 304, node N2 and node N4 are identified as candidate nodes for intersection testing using rays 0-3. The ray tracing circuitry selects node N2 to be traversed first, and node address for node N2 and its subtree is loaded onto a ray stack created for each of the rays 0-3, e.g., responsive to each ray intersecting with a parent node N1 of the node N2. Since node N2 and N3 are child nodes of node N1, the node addresses for node N3 and its subtree, are pushed onto blocks of a memory stack for future access. By pushing node metadata for node N3 onto the memory stack blocks, it is ensured that this data is not lost and re-computations for generating the data again during a future point in the traversal process is avoided.

As the ray traverses from node N2 to its subtree, sub nodes N4 and N5 are identified. Similar to nodes N2 and N3, node addresses for node N4 and N5 and their subtrees are also pushed onto blocks of the memory stack. In an example, when N4 is to be tested, data for the node is fetched from its allocated memory stack block and loaded onto the ray stack. The ray tracing circuitry then tests N4. The storing and accessing of data to and from the memory stack is performed for each node in the traversal.

In one implementation, the blocks of the memory stack storing node addresses for various nodes are linked using a memory address link such that the memory address link can be used to retrieve desired node data at a later time, e.g., in a LIFO manner. In one implementation, the ray tracing circuitry can easily determine the location of desired data in the memory stack, using memory pointers associated with each ray, wherein such memory pointers point towards a specific block of the memory stack where desired data is stored. Once this data is retrieved, the pointer is updated to reflect current position of remaining data in the memory stack. An example of ray tracing using ray stacks and memory stacks is described win FIGS. 4A-B.

In various implementations, using dynamically allocated memory stacks is advantageous in that any given ray could consume much more stack depth than other rays if required, without causing error. This benefits all ray tracing hardware, and is especially desirable in mobile parts. Additionally, the space in the memory buffer used, is a function of the memory stack depth, and not the number of rays, and/or the partitioning applied between the rays. That is, only the required virtual to physical translations in memory are performed, and cache efficiency is much higher if a memory block is smaller than a cache line, as the allocation scheme increases the likelihood that a full cache line of space will be used by the hardware.

Turning now to FIG. 4A, a block diagram for dynamic memory stack allocation for storing ray data is illustrated. As described with respect to FIG. 3, nodes are tested for intersection with rays, using dynamic memory stacks, in order to ensure that node data is maintained for nodes that would be tested against a given ray at a future point in the testing process.

In one implementation, nodes can be sorted relative to one another. For example, the bounding box of the hit set which was intersected closest to the ray origin, or the bounding box of the hit set which is intersected closest to the midpoint of the box can be selected, suggesting the ray has a better chance of striking the geometry in the subtree enclosed by the box relative to if the ray grazes the edge of the bounding box area. With the sorted set of nodes to visit next for the ray determined, the first selected node to be traversed is read from memory, however, the remainder of the state after the current intersection must be maintained to avoid repeating work at high performance cost.

In an implementation, data is pushed in reverse sorted order onto a memory stack (such as memory stack 406) such that it forms a stack (Last In, First Out) structure. If the stack is arranged as a dynamically allocated stack structure within a memory buffer created by a memory driver, memory allocation circuitry can allocate stack space (memory blocks) to each ray, as required, and connected in memory via memory links/pointers. Further, these memory chunks or blocks can be deallocated when the data is read back from a memory block of the memory stack.

In the implementation described in FIG. 4A, a memory allocation circuitry 402 assigns ray stacks 404-1 to 404-4, each associated with respective rays 0-3, as depicted. Each ray 0-3, in one example, is to be tested against various nodes of an acceleration structure. In an implementation, the ray stacks 404-1 to 404-4 are data structures created to efficiently organize and process the rays 0-3. In the implementations described in FIGS. 4A and 4B, each ray stack 404-1 to 404-4 has a finite storage allocated in the system memory. Further each ray stack 404-1 to 404-4 is associated with a memory stack 406, such that for any given ray, the last in (or top-most) block for the memory stack 406 (memory stack block 408-1) stores data for the next node to be tested against the ray. When the ray finishes testing a current node, data for the next node is popped off from the memory stack 406, stored in the associated ray stack 404 for the ray, and using this data a ray tracing circuitry tests the ray against that node. Further, each time other new nodes are identified as a result of this testing, data for such nodes is pushed onto one or more memory stack blocks 408 of the memory stack 406. Once testing is done for a current node, subsequent data is then accessed from a memory stack block 408, e.g., using memory pointers 410. This cycle continues for each ray for the duration of the traversal of the acceleration structure.

As shown in the top half of the figure, in one implementation, each ray from the rays 0-3 is assigned a ray stack block 404. Further, node data (hereinafter also referred to as node metadata or node addresses) corresponding to the ray is moved between its ray stack 404 (having finite storage) and blocks 408 from the memory stack 406 using memory pointers 410. It is noted that the ray stack 404 and the memory stack blocks 408 cumulatively store data for each ray.

In one implementation, each memory pointer 410 indicates a position of subsequent node data that is stored in the memory stack 406 for nodes that are to be tested against a given ray. In one implementation, when testing begins a ray stack 404 does not store any data. As testing progresses, data for a first node (e.g., a root node) is loaded onto the ray stack (e.g., ray stack 404-2) and the ray (ray 1) is tested against the first node. Based on this testing, other nodes (e.g., child nodes) are identified and data associated with these nodes is pushed onto a given memory stack block (e.g., memory stack block 408-1) in the memory stack 406 in a LIFO manner. The last-in data, i.e., data stored at the top of the memory stack 406 for the ray is then popped off and the associated node is tested. With this, the second-last memory block in the memory stack 406 for the ray is updated to become the top-most memory stack block in the memory stack 406.

As shown, node data for a first node to be tested against ray 1 is stored for access by a ray tracing circuitry or other processing circuitry in its ray stack 404-2. As this node is tested against ray 1, further nodes can be identified as candidates for testing, e.g., as a result of a box test. In an implementation, data for these nodes is continually stored in the memory stack 406. According to the implementation, for ray 1, data for identified nodes is shown to be stored in the memory stack 406, in memory stack blocks 408-1 and 408-2. The data is stored in a manner such that the topmost block (i.e., the last-filled block 408-1) contains data for the node to be tested next, while block 408-2 contains the data for node to be tested thereafter. Further, each block, that includes data for nodes that are candidates for intersection testing against a given ray, is linked with other such blocks using address links. As depicted, block 408-2 is linked with block 408-1 via an address link 412 and block 408-2 is the end of the memory stack for ray 1 (i.e., no more data for ray 1 is available).

In one implementation, memory pointers associated with each ray are used to point to the location of the last filled memory stack block 408 in the memory stack 406. For example, a memory pointer 410-2 associated with ray 1 indicates that block 408-2 is the last memory block for ray 1. The address link 412 can then indicate that block 408-1 is the topmost block in memory stack 406 that stores data for nodes determined as candidates for testing against ray 1.

Other ray stacks, e.g., ray stack 402-1 for ray 0, ray stack 402-3 for ray 2 and ray stack 402-4 for ray 3 can operate in a similar manner. As shown, for ray 0 the memory pointer 410-1 does not point to any memory stack block in the memory stack 406, since no node data corresponding to ray 0 is available. For ray 2, the pointer 410-3 points to memory block 408-4, wherein further data is available for consumption for ray 2. Similarly, for ray 3, the pointer 410-4 points to block 408-3 wherein more data is available for ray 3. In an implementation, memory stack blocks 408 from the memory stack 406 can be assigned dynamically for rays, using a linked-list. Linked lists are data structures used to store and organize data elements dynamically, i.e., on an ad-hoc basis without needing to follow any order. In an implementation, the last (or lower most) memory block in the linked list for a ray includes an end marker indicating the end of the memory stack for a given ray. As shown in the example in the figure, block 408-2 is the end block for ray 1 and would therefore include an end marker indicating end of the memory stack 406 allocation for ray 1.

In one implementation, the unused blocks of memory are managed using a free-list structure. For instance, the unused blocks (blocks 408-5 to 408-N) of the memory stack 406 are maintained by the memory allocation circuit 402, in a separate list called the “free-use list.” The free-use list keeps track of available memory stack blocks 408 that can be allocated for new data. When memory is requested from the ray stacks 404, the memory allocation circuit 402 searches the free-use list for a suitable memory stack block 408, removes it from the free-use list, and assigns it to the requesting ray. Once a memory stack block 408 is no longer needed, it can be returned to the free-use list to be reused for future allocations by other rays.

In one implementation, not only can data move from the blocks 408 of the memory stack 406, but when storage for any given ray stack 404 is full, the data from the ray stack's storage can be pushed from the ray stack 404 to the memory stack 406. The bottom half of FIG. 4A illustrates an exemplary allocation operation to move data from a given ray stack block 404 to the memory stack 406. When data flush is requested by a given ray stack 404, data is moved to a given memory stack block 408 of the memory stack 404. As shown in the top half of the figure, storage in ray stack block 404-4 is full and is therefore ready to push the data to the memory stack 406, in order to free up space to add new data for intersection testing.

As depicted, data from the memory block for ray 3 is pushed onto the memory stack 406 in an identified free block that has been allocated, e.g., data block 408-5. In one implementation, once the data is stored in the block 408-5, from the ray stack block 404-4, the new data in the block 408-5 is linked to a previous block containing the data for ray 3, using linked lists. For instance, since data block 408-3 contains supplemental ray data for ray 3, newly stored ray data in block 408-5 is linked to data in block 408-3 using a memory link 414, as shown. In one implementation, the new data and the memory link/pointer 414 are each stored in the data block 408-5 for ray 3. As seen in the example of FIG. 4A, the memory stack 406 includes multiple logical or memory stacks (data structures). One such stack includes blocks 408-1 and 408-2 connected via link 412, and the other stack includes blocks 408-3 and 408-5 connected via link 414. Further, the free-use list is updated to reflect that data block 408-5 is now consumed and no longer free for allocation.

In an implementation, in order to maintain the sanctity of stored data and to ensure that data retrieval is performed seamlessly during subsequent intersection testing, the memory allocation circuitry 402 updates the memory pointer 410-3 for ray 3 to reflect the top-most memory block in the memory stack 406 for ray 3. As shown, since block 408-5 is the top-most memory block for ray 3, the pointer 410-4 for ray 3 is updated to reflect the value 408-5. The intersection testing continues with multiple rays using the ray stack blocks 404 in a similar manner and data is pushed off to the memory stack blocks 408 seamlessly as and when required, without needing to pre-assign specific memory storage for each ray.

Turning now to FIG. 4B, a block diagram for dynamic memory stack deallocation is illustrated. Similar to FIG. 4A, the top half of the figure illustrates one or more blocks 408 of the memory stack 406 being allocated to different ray stacks 404-1 to 404-4 (each associated with a different active ray, e.g., rays 0-3). Further, the bottom half of the figure illustrates a block 408 of the memory stack 406 being deallocated.

As depicted, the memory allocation circuit 402 assigns pointers to each ray, wherein each pointer points to a top-most memory stack block 408 in the memory stack 406 storing data for the ray. For example, for ray 1, the pointer 410-2 value is 408-2, which indicates that last-in or top-most data for ray 1 is stored at the block 408-2. Further, the block 408-2 storing data for ray 1 is further linked to the block 408-1 via a memory link 412, indicating that the next block storing data for ray 1 is block 408-1. In an example, block 408-1 marks the end of data storage for ray 1.

When deallocation of data from the memory stack 406 is to be performed, e.g., owing to ray stack 404-2 requesting more data to consume, the memory allocation circuitry 402 can determine that block 408-2 stores the last-in data for ray 1. As described, this determination can be done using the memory pointer 410-2. Responsive to determining that block 408-2 stores the data requested by ray stack 404-2 in the memory stack 406, the memory allocation circuitry 402 loads the data from the block 408-2 to the ray stack 404-2, to be consumed by ray 1. As shown in the bottom-half of the figure, data from block 408-2 is loaded for ray 1 in the ray stack block 404-2, thus emptying the block 408-2.

In an implementation, once this data is accessed by the ray 1, the memory allocation circuit 402 can update the pointer 410-2 for ray stack 404-2 to reflect the latest block in the memory stack 406 that contains the node data for ray 1. In this example, the pointer 410-2 is updated to reflect the value 408-1, since block 408-1 stores the next ray data for ray 1 in the memory stack 406. Further, the block 408-2 is freed up, e.g., for use by other rays and the link 412 between blocks 408-1 and 408-2 is accordingly terminated.

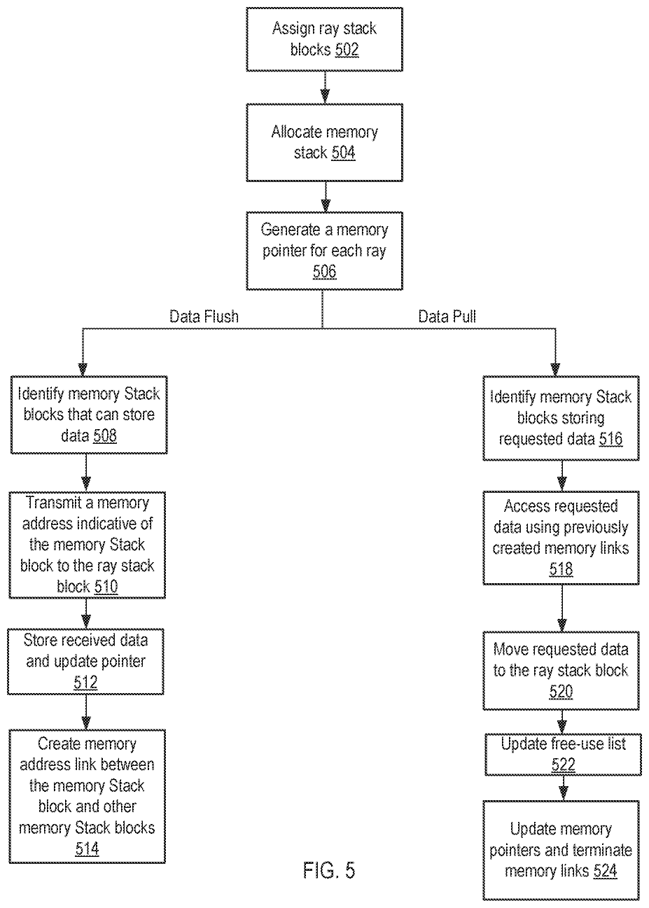

Turning now to FIG. 5, an exemplary method for allocation and deallocation of memory stacks for ray tracing is illustrated. In an implementation, a processing unit (such as ray tracing circuitry 280 depicted in FIG. 2) selects nodes of a hierarchical acceleration structure to be processed and generates one or more rays to be tested for intersection against the objects contained in the node. Each ray is assigned a ray stack such that during intersection testing, node data for nodes identified as a result of the testing is moved, based on the traversal progress, between the ray stack and a memory stack. In an implementation, data movement between a ray stack and a memory stack includes either data flushing from the ray stack block to the memory stack block (i.e., memory stack allocation) or data pulling (consumption) of data from the memory stack block by the ray stack block (i.e., memory stack deallocation). Further, in an allocation process, the data storage to the memory stack can be initiated, e.g., when the ray stack for a ray is full and cannot store additional data generated during the ray tracing process. Similarly, in a deallocation process, data can be moved from the memory stack back to the ray stack dynamically, when the ray stack has available storage to store data.

In another implementation, responsive to each allocation and deallocation process, memory pointers associated with each ray are updated to reflect the latest topmost block in the memory stack wherein ray data for a given ray is stored. Further, memory links between multiple blocks containing data for the same ray are created and stored in the last-in data, for ease of data retrieval for future processing by the ray.

In an implementation, ray stacks are assigned to the selected rays, e.g., by a ray tracing circuitry (block 502). In an example, each ray stack is associated with a given ray that needs to be tested against a set of objects or geometry. The rays may share some common properties or attributes, such as originating from the same pixel or being part of a coherent group of rays. In one implementation, the ray stacks are assigned supplemental memory buffers or memory pools, e.g., in the form of a memory stack (block 504). The memory stack is configured to store data resultant from the intersection testing, dynamically and without the need to pre-assign memory stack blocks for a given ray stack block.

In one implementation, memory pointers are generated and assigned for each ray (block 506). As described in the foregoing, a memory pointer ensures that a last-filled block in the memory stack, that stores node data for a given ray, is clearly identified so as to facilitate ease of flushing data from the ray stack to the memory stack or pulling data from memory stack. Further, each time data is flushed to or pulled from the memory stack, these memory pointers can be updated to reflect the next block of memory (which now becomes the last-filled block) wherein data is stored corresponding to the given ray.

In case a ray stack requests flushing of data to the memory stack (“Data Flush” branch of the method), blocks in the memory stack, that can store the data to be flushed, are identified (block 508). In an implementation, these blocks are identified based on a free-use list that represents blocks currently unused in the memory stack. Once a free to use memory stack block is selected, the memory address for the block is identified and transmitted to the ray stack (block 510). Based on the memory address, data is pushed from the ray stack and stored at the identified block, and the memory pointer for the ray is updated (block 512). In an implementation, the updated memory pointer can indicate the block to which data has been pushed, since this block is the topmost memory block for the ray. Further, memory links are created between other blocks storing additional data for the ray and the topmost block (block 514). In an implementation, these links can be stored in the last-filled block corresponding to the ray in the memory stack.

In another implementation, if data is to be consumed or pulled from the memory stack to a ray stack (depicted by “Data Pull” branch of the method), a block storing the requested data in the memory stack is identified (block 516). The block can be identified based on a memory pointer currently assigned to the ray requesting the data. The requested data can be accessed from the identified block (block 518). In an implementation, data from a single block can be accessed or data from multiple linked blocks can be accessed, depending upon how much data is requested by the ray. In case data from multiple blocks is to be accessed, these blocks can be identified based on memory links between them.

Once the data is accessed, the data is loaded onto the ray stack for processing by the ray (block 520). Further, a free-use list is updated to reflect any blocks in the memory stack that have freed up (block 522). In an implementation, owing to the blocks freeing up, any memory links originating from the freed-up blocks to other blocks are terminated, and the memory pointer for the ray is updated (block 524).

In one implementation, parallel BVH traversal involves multiple work items cooperating to traverse a single physical ray. This has significant benefits in terms of accelerating traversal performance, and also in producing a more area efficient solution by balancing the computational resources assigned to work items. Further, as memory storage on a per ray basis decreases, this further reduces the overall cost of the ray tracing system, since scaling such a system becomes cheaper.

In an implementation, each work items each has its own traversal memory stack, and is associated with one physical ray at any given time, which is indexed by a local Ray ID into ray tracing system storage (e.g., memory 284 depicted in FIG. 2), and via a Shader Ray ID into any storage within a control unit cache. However, if parallel BVH traversal is active, ray stacks (example ray stack 404 described in FIG. 4) cannot be indexed by a Shader Ray identifier (shader ray ID). In an example, a “shader ray ID” refers to a unique identifier associated with each ray being traced by a shader program. It is a value that helps identify and track individual rays as they propagate through a scene and interact with objects. As there is a 1:1 mapping between a physical ray and a Shader Ray ID, ray stacks cannot be indexed by the shader ray ID. Therefore, in parallel BVH traversal, each work item requires its own memory stack. Even though the number of work items may be larger than the number of local ray ID within the ray tracing system, but this number may not be as large as the shader ray ID, as the latter is sized to index rays for their whole lifetime, including post traversal shader binning and execution. On the other hand, work item IDs and local ray IDs are only required to be persistent for traversal and traversal within the ray tracing system, respectively.

In one implementation, each work item contains the following information:
Ray ID—the local Ray ID associated with the work item: This is used to index the ray tracing system storage to obtain or update ray data during traversal;
Work Item Head—This is a Boolean value defining whether the work item is the head of the linked list of work items working on the same ray. The head work item is defined as the work item which is the first in serial traversal order;
Next work ID—The next work item ID in the linked list;
Current node—The top of the stack for this work item; and
T value (optional)—A value to store a proactively performed ray-triangle intersection. Work items are added to the list of work items processing the traversal of a ray when box hits are returned by a work item already working on the ray.

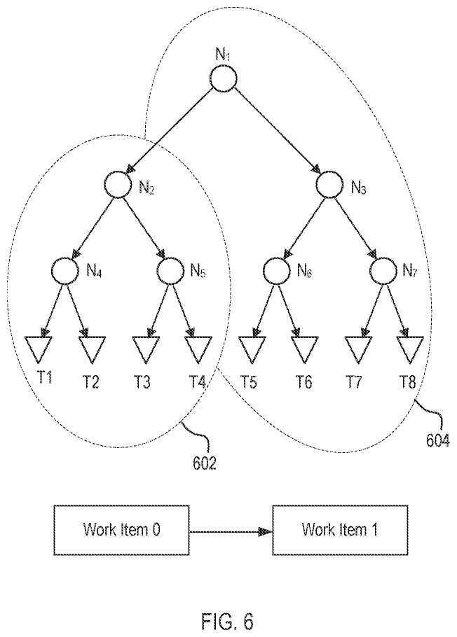

Turning now to FIG. 6, an exemplary parallel processing for a bounding volume hierarchy (BVH) traversal using work items is depicted. In the example depicted in FIG. 6, work item 0 is working on a ray and intersects parent node N1, returning child hits on nodes N2 and node N3. In an implementation, node N2 can be the first sorted hit and work item 0 will traverse into it (shown by boundary 602), while the next sorted hit, node N3 is handled by work item 1 (shown by boundary 604) to be the first node it requests and traverses. When children of node N3 are returned, they are pushed to a ray stack (not shown) indexed by work item 1. When children of node N2 are returned, they are pushed to a ray stack (not shown) indexed by work item 0, and so on. In an implementation, from the moment work item 1 is created, both work items 0 and 1 are traversed independently, but the relationship between the work items is stored in the head and next work item ID fields. For example, work item 0 is the head of the linked list as it received the first sorted hit from parent node N1, and it points to work item 1 as the next work item in the list. Work item 1 is not the head, and points to no other work item as it is the end of the linked list.

In one implementation, knowing whether a work item is the head of the linked list for a ray allows the ray tracing system to determine if it can act upon triangle hits in terms of shortening the ray, or invoking any hit shading (AHS). AHS may refer to returning to the shader to run a texture lookup to determine if a ray strikes a portion of the triangle which is opaque or not. This can be typically used in cases where rendering foliage is involved. If a work item is not the head of the list, to preserve determinism triangle effects are resolved, until the work item is the head of the list. For instance, in the depicted example, such a scenario may occur in when work item 0 empties its memory stack, and runs out of work to perform, and then follows the next work item ID link, to set work item 1 as the new head.

In an implementation, using a dynamic memory stack allocation and deallocation scheme (as described with respect to FIGS. 4-5) allows a memory stack, which is memory backed, to be used dynamically to store ray data for multiple rays without needing fixed mappings between a ray or work item ID and a position in that memory stack. In an implementation, the depth of any memory stack relative to another is an arbitrary function of the scene geometry, BVH organization and the ray itself traversed, and therefore cannot be predicted or bounded. The memory stack is, therefore, more efficiently used as all memory consumed will be for storing data rather than reserving space that may never be utilized.

In one implementation, memory blocks of memory stack are allocated dynamically by dedicated hardware (e.g., memory allocation circuitry 282 in FIG. 2). These are then linked together when a stack is formed of multiple blocks by a single linked list with each block pointing to the next block deeper in the stack. The deepest block is known as the tail. The top block from which data is pushed or popped is known as the head. In general, each work item is associated with local data which is the top stack entry or block, and a pointer to the next block in the memory blocks in the memory stack.

In response to identifying a reassignment condition, a work item processing a given ray can be assigned to process another ray. In some examples, the reassignment condition is identified when a work item is not executing on desired operational parameters and/or a number of work items processing a ray is below a threshold. According to an implementation, this reassignment of work item from one ray to another can be done by performing a “stitching” or “linking” operation.

In an example, “stitching” can refer to connecting one memory stack assigned to a work item to another memory stack assigned to a different work item working on the same ray. In an implementation, linking a memory stack tail of one memory stack to a memory stack head of another memory stack can be defined as stitching the memory stacks together. This combines the data to form a larger memory stack. In one implementation, the topmost work item (e.g., work item 0) is never stitched to other work items, but the memory stack from the work item next in line (work item 1) can be stitched to another work item's memory stack, to create a larger in order stack of the previously two separate work items. In an implementation, the larger memory stack follows a traversal order from the head down, i.e., a series of memory blocks linked or stitched are at the bottom of a target memory stack. Further, these memory blocks are only processed after the target memory stack has been processed.

In an implementation, the stitching of memory stacks can be performed, e.g., via one write per memory stack combination. For example, a series of N memory stacks can be linked via N−1 writes to the memory, wherein N is a positive integer. This allows rapid release of a work item for processing another ray, as the current ray data it is working on can just be combined with another work item working on the ray and hence the data remains retained. The work item is then reassigned to process a different ray.

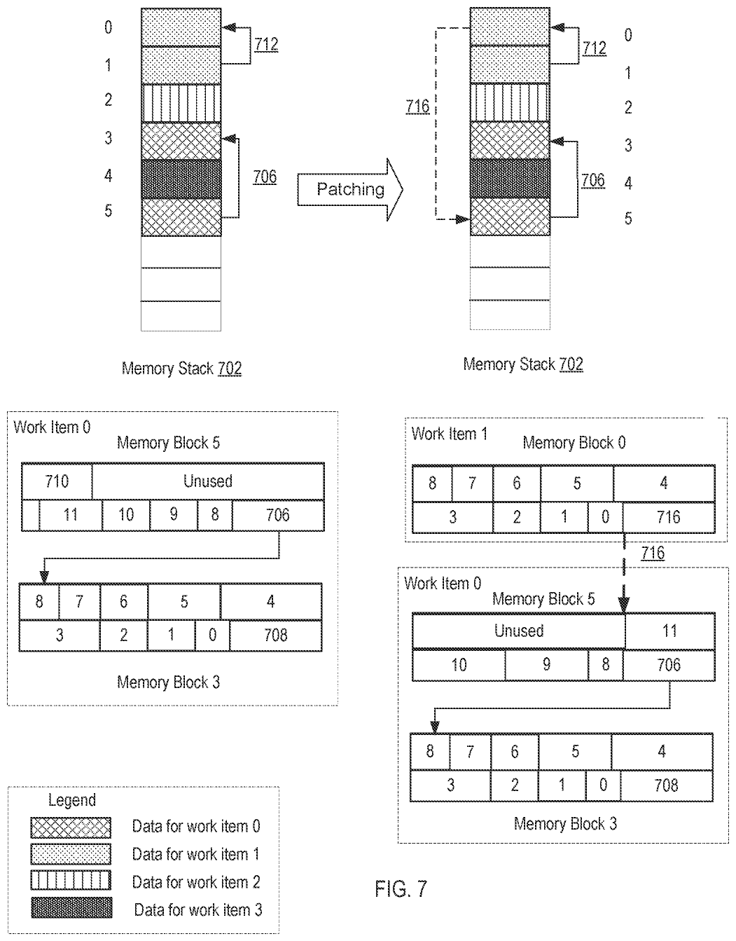

Turning now to FIG. 7, an exemplary linking (or stitching) operation for reassigning work items has been illustrated. As shown in the figure (see legend at the end of the figure), a memory stack buffer 702 stores data for four different work items, i.e., work items 0, 1, 2, and 3. As depicted on the top left side of the figure, the memory stack 702 stores data for work item 0 in memory blocks 3 and 5, linked using memory link 706; data for work item 1 in blocks 0 and 1 linked using link 712; data for work item 2 in block 2; and data for work item 3 in block 4.

The detailed view of the individual memory blocks 704 of the memory stack 702, for a given work item, is also shown. As depicted, data for work item 0 is stored in memory blocks 3 and 5 that are shown on the bottom lefthand side of the figure. Both the memory block 3 and the memory block 5 include data pertaining to various nodes to be processed by the work item 0. Further, the memory block 5 is linked with the memory block 3 in a last-in-first-out manner. That is, in operation, data is filled first in memory block 3 and the remaining data is filled in memory block 5 for work item 0 (in other implementations data can be filled in memory blocks out of order as well). During consumption of data, data from memory block 5 is consumed first, following consumption of data from memory block 3. Further, memory block 5 links to memory block 3 using the memory link 706.

In an implementation, as described above with respect to FIGS. 4 and 5, as and when memory blocks in a memory stack are required to save additional data for a ray (or a work item), memory blocks are dynamically assigned and linked to previous memory blocks storing other data for the same ray. In the example shown in FIG. 7, when memory block 3 is full, a memory allocation circuitry can assign the next available memory block from the memory stack 702, to store data for the work item 0. In this example, the next available memory block is memory block 5, and therefore memory block 5 is filled with additional data for work item 0. The memory block 3 and memory block 5 are then linked with the memory link 706. In an example, the memory link 706 is stored in the memory block 5 (as shown), signifying that memory block 5 is the head of the memory stack for work item 0. Further, an end marker 708 is stored in memory block 3, indicating that memory block 3 is the end of the memory stack for work item 0. In other words, the memory stack for work item 0 includes two individual memory blocks, i.e., memory block 5 and memory block 3. Memory block 5 can also store an indicator 710 indicating a size of the unused space in the memory block 5. In an implementation, this indicator 710 is updated continuously as memory block 5 is filled with more data (or existing data from the block is consumed) and therefore can be used to identify remaining storage space in the memory block 5.

In an implementation, when a reassignment condition is identified, one or more work items can be reassigned to work on different rays than the one these work items are currently processing. For the purposes of this description, it is assumed that work items 1 and 0 are processing the same ray. In such a case, if work item 1 is selected as a candidate for reassignment to another ray, the last memory block for work item 1 is linked to the head of the work item 0. This is because work item 1 is at the “head” or top of the linked list of work items working on the same ray, and work item 0 is the next work item in line. If the order is to be reversed, the “tail” or end of work item 0 would be linked to the head of work item 1.

As shown in the top right of the figure, the last memory block of work item 1, i.e., memory block 0 is linked or linked to the head memory block of the work item 0, i.e., memory block 5, using memory link 716. This is further depicted in the detailed view of the memory blocks 0, 3, and 5 on the bottom righthand side of the figure. As shown, the last memory block for work item 1, i.e., memory block 0 is linked via link 716 to the head memory block 5 of the work item 0. In doing so, it is ensured that data for work item 1, stored until a point in processing time when such a reassignment is required, is maintained within the memory stack 702 and therefore this data does not need to be recomputed when needed again (e.g., when other work item need to work on the ray corresponding to the preserved data).

In an implementation, the stitching of memory stacks for work item 0 and work item 1 can be performed, e.g., via one write per memory stack combination. For example, a given series of N memory stacks can be linked via N−1 writes to the memory, wherein N is a positive integer. Therefore, for the memory stacks for work items 0 and 1 can be stitched together using just a single write command (since, the number of memory stacks N=2, the number of write commands are 2−1=1). The stitching together of stacks for work items allows for rapid release of work item 1 for processing another ray, as the current ray data it is working is seamlessly combined with work item 0, thereby retaining the data. The work item 1 is then reassigned to process a different ray.

In one implementation, the reassignment condition can occur when a work item is not processing a ray at desired operational parameters. In another implementation, the reassignment condition can also be identified when a given ray is processed by a number of work items that are less than a predetermined threshold. Other reassignment conditions are possible and contemplated.

In an implementation, the reassignment of work items can be advantageous in reducing a BVH traversal width. The traversal width for a BVH can be defined by the number of nodes in the BVH tree that can be traversed in parallel during ray traversal. There may be certain conditions encountered during the parallel traversal where a reduction in traversal width for the BVH is required, i.e., a number of work items working on a given ray must be reduced. These conditions include conditions such as increased memory bandwidth, hardware limitations, execution time for traversal, and the like. In some implementations, a low occupancy of rays in the system can trigger a hardware to determine that the ray traversal needs to be widened, in order to complete the traversal faster. To do so, more new rays are generated and these require work items to process. Therefore, freeing up work items by stitching their stacks allows for rebalancing work item use across a dynamically changing population of rays.

This above-described stitching methodology is advantageous in that it avoids drawbacks that would be suffered if a ray traversal stack was managed in another means, e.g., either as a finite stack with some form of overflow recovery by repeating work, or as a statically organized memory backed stack. Either of these approaches would involve moving data around from one location to another, either from local storage in hardware to a memory buffer initially using a series of write operations, and then this data would have to be read back when moving to the lower work item stack content or from one location in a memory buffer to another (several read and write operations). Further, the stitching is done using only write operations and therefore does not have associated performance impact in waiting for memory latency. Data is not moved, only memory links are repurposed.

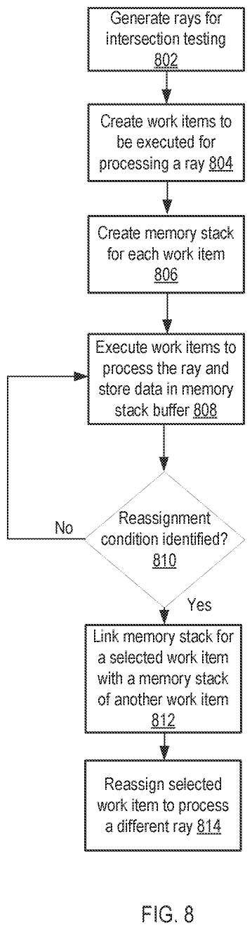

Turning now to FIG. 8, an exemplary method for reassigning work items during parallel BVH traversal using memory stack linking is illustrated. As described with respect to foregoing, when a ray tracing circuitry performs parallel BVH traversal using work items, if a work item is to be reassigned from working on one ray to another, data generated by that work item until such reassignment is to be preserved, in order to avoid regeneration of the data. In an implementation, the data can be preserved by stitching memory blocks of the work item to be assigned with memory blocks of another work item also working on the same ray.

In an implementation shown in FIG. 8, during BVH traversal rays are generated for intersection testing with different objects in a selected node (block 802). As traversal continues, work items are created, such that processing of each ray can be handled by at least one work item (block 804). As an example, when children of a selected node are to be traversed, these are pushed to a ray stack indexed by a first work item. Further, when children of a subsequent node are to be traversed, these are pushed to a ray stack indexed by a second work item, and so on. Further, in some implementations, multiple work items can process a single ray.

In an implementation, in order to store the data for these work items, a memory stack is created for each work item (block 806). In an example, each memory stack can include one or more memory blocks or memory blocks containing data, e.g., pertaining to nodes and respective objects to processed by the work item. In order to process these, i.e., to process the rays that the work items relate to, the work items are executed and the resultant data is stored in the memory stack (block 808). In one implementation, the memory stack can be accessed to both write data to the memory stack, as well as, to consume data from the memory stack. This data movement can be achieved dynamically by using a linked list, as described with respect to FIG. 5.

During execution of the work items, the ray tracing circuitry can determine whether a reassignment condition is identified (conditional block 810), i.e., whether a given work item is to be reassigned from working on a current ray to another ray. If such a reassignment condition is not identified (conditional block 810, “no” leg), the ray tracing circuitry continues to execute the work item for processing a given ray.

Otherwise, if a reassignment condition is identified (conditional block 810, “yes” leg), a memory stack, corresponding to the work item working on the ray and selected for reassignment, is linked with a memory stack of another work item working on the same ray (block 812). In an implementation, such a linking may be referred to as “stitching” or “linking” of memory stacks. In an implementation, linking a memory stack tail of one memory stack to a memory stack head of another memory stack can be defined as stitching the memory stacks together. This combines the data to form a larger memory stack, which is accessible in traversal order from the head down, i.e., from a head of a memory stack to lower stacks, with a series of memory blocks linked or stitched at the bottom of the target memory stack. Further, these memory blocks are only processed after the target memory stack has been processed.

In an implementation, the stitching of memory stacks can be performed, e.g., via one write per memory stack combination. For example, a series of N memory stacks can be linked via N−1 writes to the memory. This allows rapid release of a work item for processing another ray, as the current ray data it is working on can just be combined with another work item working on the ray and hence the data remains retained. The work item is then reassigned to process a different ray. Once the stitching of memory stacks is complete, the work item can be assigned to work on another ray (block 814).

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
ray tracing circuitry configured to assign, to a ray, at least one ray stack in a first memory; and
memory allocation circuitry configured to allocate at least one memory block to the ray from a memory stack in a second memory, responsive to intersection testing of the ray against one or more nodes of a hierarchical acceleration structure.

2. The system as claimed in claim 1, wherein the ray stack has a fixed size and the memory stack has a variable size.

3. The system as claimed in claim 2, wherein the memory allocation circuitry is configured to:
store, in the at least one memory block, data associated with a current node of the hierarchical acceleration structure being traversed by the ray; and
create a link between the at least one memory block and one or more other memory blocks in the memory stack associated with the ray.

3. The system as claimed in claim 1, wherein the memory allocation circuitry is further configured to associate the ray with the at least one memory block.

4. The system as claimed in claim 1, wherein the ray stack is in a memory local to the ray tracing circuitry, and the memory stack is in a memory that is not local to the ray tracking circuitry.

5. The system as claimed in claim 1, wherein the memory allocation circuitry is configured to identify the at least one memory block using a free-list structure.

6. The system as claimed in claim 1, wherein the memory stack comprises a plurality of memory blocks in a linked list data structure.

7. The system as claimed in claim 1, comprising a plurality of ray stacks, each associated with a separate memory stack.

8. A method comprising:
assigning, to a ray by ray tracing circuitry, at least one ray stack in a first memory; and
allocating, to the ray by memory allocation circuitry, at least one memory block from a memory stack in a second memory, responsive to intersection testing of the ray against one or more nodes of a hierarchical acceleration structure.

9. The method as claimed in claim 8 wherein the ray stack has a fixed size and the memory stack has a variable size.

10. The method as claimed in claim 8, further comprising:
storing, in the at least one memory block, data associated with a current node of the hierarchical acceleration structure being traversed by the ray; and
creating a link between the at least one memory block and one or more other memory blocks in the memory stack associated with the ray.

11. The method as claimed in claim 8, further comprising associating the ray with the at least one memory block.

12. The method as claimed in claim 8, further comprising identifying the at least one memory block using a free-list structure.

13. The method as claimed in claim 8, wherein the memory stack comprises a plurality of memory blocks in a linked list data structure.

14. The method as claimed in claim 8, further comprising associating each of a plurality of ray stacks with a separate memory stack.

15. A system comprising:
a local buffer; and
processing circuitry configured to:
assign, to a ray, at least one ray stack comprising a plurality of memory blocks in the local buffer; and
allocate at least one memory block in a memory device to the ray stack, wherein the memory device is external to the system, responsive to intersection testing of the ray against one or more nodes of a hierarchical acceleration structure.

16. The system as claimed in claim 15, wherein the local buffer comprises a plurality of ray stacks, each having a fixed size.

17. The system as claimed in claim 15, wherein the processing circuitry is further configured to store data that associates the ray stack with the at least one memory block.

18. The system as claimed in claim 17, wherein the processing circuitry is configured to store data that identifies a memory block in the memory device that remains to be processed.

19. The system as claimed in claim 15, wherein the processing circuitry is configured to identify the at least one memory block using a free-list structure.

20. The system as claimed in claim 15, wherein the memory device comprises a plurality of memory blocks in a linked list data structure associated with a ray stack.
